(19) United States
(12) Patent Application Publication
(10) Pub. No.: US 2007/0221741 A1
(43) Pub. Date: Sep. 27, 2007

(54) Connector terminal system and wiring method for thermostat

(75) Inventors: Phillip Ryan Wagner, Baltimore, OH (US); Nicholas Ashworth, Dublin, OH (US); Joseph P. Rao, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/389,982

(22) Filed: Mar. 27, 2006

(51) Int. Cl. G05D 23/00

(52) U.S. Cl. 236/94

(57) ABSTRACT

A thermostat having a terminal connection mechanism and method that provides ease of installation of the thermostat and the heating, ventilating and air conditioning (HVAC) wiring is provided. One embodiment allows any wire to be attached to any terminal. This thermostat includes logic for determining an identity of the wire connected to an HVAC system component. The control logic determines a characteristic of the HVAC system component and compares the characteristic to a known characteristic of the HVAC system component. Environmental responses may also be monitored to identify the HVAC component. The terminal of the thermostat may be color coded to further ease installation. Tool-less terminal connectors may also be used to still further ease installation.

### FIELD OF THE INVENTION

This invention generally relates to heating, ventilating and air conditioning (HVAC) control systems and, more particularly, to thermostats employed in those systems.

### BACKGROUND OF THE INVENTION

In most structures (e.g., residential dwellings, commercial buildings, etc.), a thermostat is used to control a heating, ventilating, and air conditioning (HVAC) system to regulate the temperature within the structure. The thermostat includes, among other components, a terminal block. The terminal block is a simple mechanical device used to organize and connect each of several wires from the HVAC system to the thermostat. When the wires are properly connected, the thermostat is able to control the HVAC system.

One of the many types of commercially available terminal blocks includes an array of terminals formed from screws and terminal plates. Each terminal includes one of the screws threadably mated with a threaded aperture in one of the terminal plates. When the screw is threadably driven in a reverse direction, the screw and the terminal plate separate from each other. While the two components are spaced apart, one of the wires from the HVAC system is, for example, looped around the shaft of the screw. With the wire in this position, the screw is threadably driven in a forward direction to draw the screw and the terminal plate toward each other. As the screw is driven closer to the terminal plate, the wire is securely clamped against the terminal plate by the head of the screw and an electrical connection is established. After each of the wires from the HVAC system is connected to the terminal block of the thermostat in this or a similar fashion, the thermostat is able to control and/or manage the HVAC system.

Unfortunately, the task of connecting the HVAC system wires to the terminal block of the thermostat is not always quick and easy. As any electrician, handyman, or even consumer who has installed a thermostat knows, the process can be frustrating for a variety of reasons. For example, the terminals tend to be relatively small. Because of their diminutive size, the terminals are subject to breakage. If too large a screwdriver is used, if too much torque is applied to the screw, and the like, the terminal block may be damaged. Moreover, if the screwdriver happens to slip off the screw, the screwdriver can ruin the terminal block and/or puncture the thermostat housing and fatally damage the internal circuitry of the thermostat.

In addition to the above, the connection process is made even more difficult as a result of the configuration of the terminal block. For example, each terminal is usually separated from adjacent terminals by a thin, insulating wall. These insulating walls act as a small retaining wall or fence to ensure that wires from the HVAC system do not undesirably make contact with the wrong terminal plate. However, in performing this function, the insulating walls can also hamper the installation process by restricting the amount of space available for maneuvering. For example, the insulating walls can make looping the wire around the shaft of the screw very difficult.

Still further, the installation procedure is sometimes made more difficult due to the location of the terminal block. The terminal block is generally imbedded in a rear portion of the thermostat. Therefore, during installation, the installer of the thermostat and/or the screwdriver or other required tool might have to be manipulated into an uncomfortable or awkward position. Since the HVAC wires are often not long enough to set the thermostat on a surface, one hand is needed to hold the thermostat while the other is used to position the wire and then screw the terminal. Additionally, the installer may have to crane his neck to see behind the thermostat, stand on a stool to see above the thermostat, crouch to see below the thermostat, and the like if the wiring is particularly short. Moreover, the screwdriver may have to be positioned very close to a wall where the thermostat is being mounted. As such, providing the rotational force needed to loosen or tighten the screws within the terminal block becomes difficult.

In an effort to mitigate the fact that the coupling of wires to the terminal block often takes place in tight quarters, an installer sometimes decides to remove the screw from the terminal block and position the wire thereon before replacing on the terminal block. However, this all too often it leads to the screw falling to the floor and becoming lost or misplaced. When this occurs, the installer ends up spending a good amount of time searching for the screw or obtaining a replacement. In either case, valuable time is wasted.

To make matters worse, in some instances the individual terminals within the terminal block are either poorly marked, confusingly marked, or not marked at all. Therefore, the installer is unable to determine which of the various wires from the HVAC system should be connected to each of the terminals. If the wires and terminals are improperly matched, the thermostat will most certainly fail to operate as desired. If the wiring diagram, owners manual, or similar documentation or literature is, for some reason, unavailable or lost, an inadequately marked or unmarked terminal plate can be especially difficult with which to cope.

There exists therefore, a need in the art for a thermostat that can be easily, quickly, and conveniently connected to the HVAC system. The invention provides such a thermostat. These and other advantages of the invention, as well as additional inventive features, will be apparent from the description of the invention provided herein.

### BRIEF SUMMARY OF THE INVENTION

In view of the above, the present invention provides a new and improved thermostat that overcomes the above and other problems existing in the art. More particularly, the present invention provides a new and improved thermostat that can be easily, quickly, and conveniently connected to the HVAC system.

The present invention provides a thermostat having a connector terminal system and utilizing a wiring method that provides a greatly simplified installation experience to the installer of the thermostat. In one embodiment, the terminal system includes tool-less connectors to make the electrical and mechanical connection to the HVAC wires. In another embodiment, the individual terminals are color coded to match the color of the wire to which the individual terminal is to be associated.

In an alternate embodiment of the present invention, a thermostat is provided that allows for any wire from the HVAC system to be connected to any terminal connector on the thermostat without regard to location. This thermostat is able to “learn” which wires from the HVAC system are connected to each of the terminals in the terminal block. Preferably, this learning or detection is made by measuring and/or observing one or more electrical and/or environmental characteristics of the connected wires. As a result, the wires from the HVAC system can be connected to the thermostat in any arrangement or pattern and the HVAC system will still operate properly.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front view of an exemplary embodiment of a thermostat constructed in accordance with the teachings of the present invention;

FIG. 2 is a rear view of the thermostat of FIG. 1 highlighting a terminal block having a plurality of terminals;

FIG. 3 is simplified schematic of a heating, ventilating and air conditioning (HVAC) system controlled by the thermostat of FIG. 1; and

FIG. 4 is a rear view of one embodiment of the thermostat of FIG. 1 having a terminal block with tool-less terminals.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

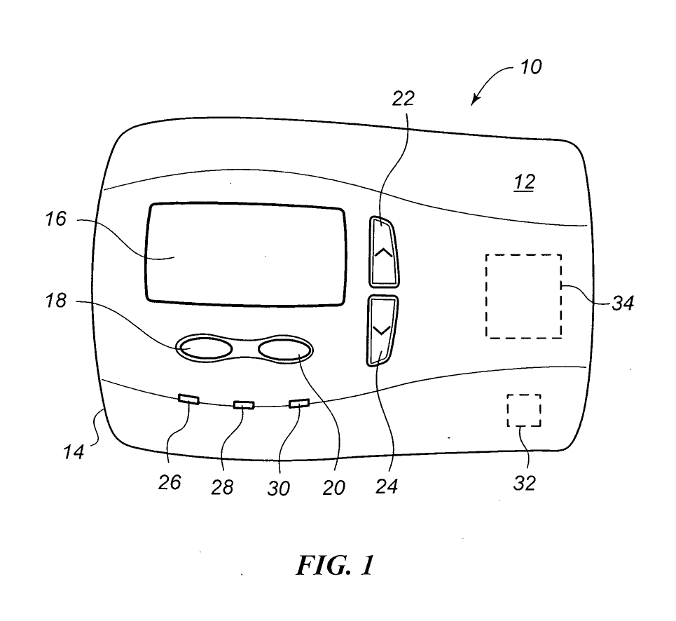

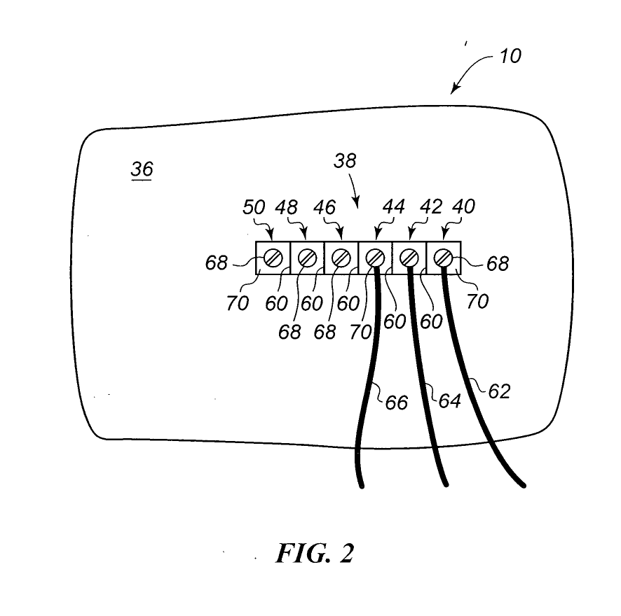

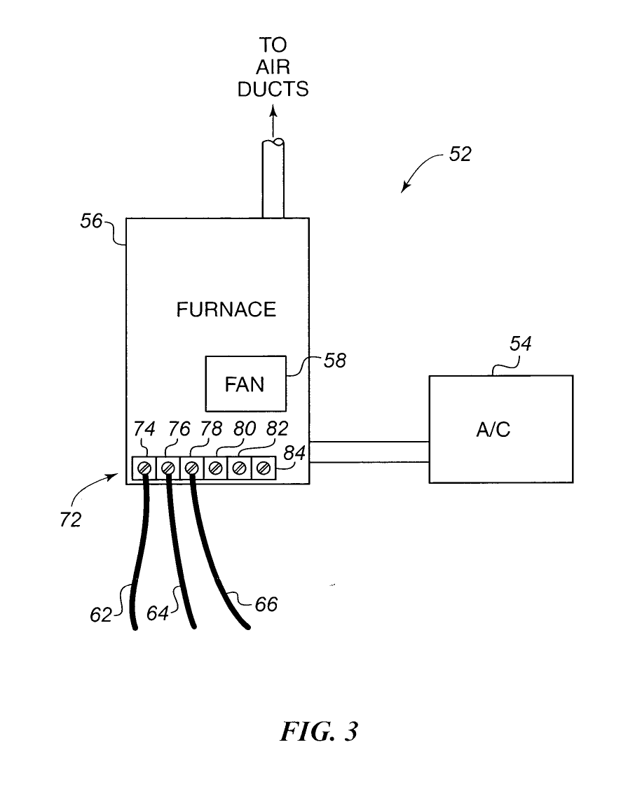

Referring to FIGS. 1 and 2, a thermostat 10 constructed in accordance with the teachings of the present invention is illustrated. In FIG. 1, a front face 12 of the thermostat 10 exhibits a housing 14, a display 16, soft keys 18, 20, adjustment keys 22, 24, operating mode visual indicators 26, 28, 30, an internal temperature sensor 32, and control logic 34. In FIG. 2, a rear face 36 of the thermostat reveals a terminal block 38 having a plurality of terminals 40, 42, 44, 46, 48, 50. As will be more fully explained below, the thermostat 10 is able to control and/or instruct a heating, ventilating and air conditioning (HVAC) system 52 shown in simplified form in FIG. 3.

Before describing details of the invention, the following will provide a description of one embodiment of a thermostat to which embodiments of the present invention are particularly well suited. However, those skilled in the art will recognize from the following that other embodiments of a thermostat or other control unit may find benefit from embodiments of the present invention. As such, the following should be taken as illustrative of one operating environment only, and is not presented by way of limitation.

Referring back to FIG. 1, the housing 14 of the thermostat 10 is formed from one of a variety of suitable materials such as, for example, plastic. The housing 14 is used for mounting or enclosing external components (e.g., the display 16, the soft keys 18, 20, the adjustment keys 22, 24, the operating mode visual indicators 26, 28, 30, etc.) and protecting internal components (e.g., the internal temperature sensor 32, the control logic 34, etc.). The housing 14 is preferably available in a variety of different shapes and/or colors to suitably match the decor or color scheme within a residential dwelling, office building, or other type of structure.

The display 16 displays programming, system, and ambient information regarding the operation of the thermostat 10, the HVAC system 52, environmental conditions within the structure, and the like. The display 16 can illustrate numbers, text, icons, and the like. The displayed items can be static or dynamic if a more advanced the thermostat 10 is selected. The display 16 may take various forms well known in the art and, in a preferred embodiment, the display is a dot matrix LCD display.

Using the display 16, the consumer may activate various programming and control functions via the pair of soft keys 18, 20. The functionality executed by these soft keys 18, 20 varies depending upon the program state the thermostat 10 is in at the time one of the soft keys 18, 20 is depressed. The particular functionality that will be instituted upon selection of one of the soft keys 18, 20 is displayed in a portion of the display 16 proximate the key 20, 22 which will institute that function. That is, the function that will be instituted upon selection of soft key 18 will be located generally in the lower left hand portion of the display 16 while the functionality that will be instituted by selection of soft key 20 will be located generally in the lower right hand portion of user display 16. These functional indicators may change depending on the program state and mode in which the thermostat is currently operating.

In addition to the soft keys 18, 20, this embodiment of the thermostat 10 also includes adjustment keys 22, 24. These adjustment keys 22, 24 may serve to adjust a currently selected parameter up or down, such as in the case of setting the control temperature at which the thermostat will maintain the ambient environment. Additionally, these keys 22, 24 may scroll through the available data for a selected parameter, such as scrolling through alphanumeric data that may be selected for a given parameter. These keys 22, 24 may also function as soft keys depending on the programmatic state in which the thermostat is operating. When this functionality is provided, the function that will be instituted by selection of key 22 will be provided generally in the upper right hand corner of display 16, while the functionality that will be instituted by selection of key 24 will be displayed generally in the lower right hand corner of the display 16. In addition to the above, other use input means, such as an alphanumeric keypad, user rotatable knob, a touch screen, and the like, may be utilized instead of the buttons 18-24 illustrated in the embodiment of FIG. 1.

The indicators 26-30 provide a visual indication of the current operating mode of the thermostat 10 and/or the HVAC system 52. In the embodiment illustrated in FIG. 1, indicator 26 illuminates while the thermostat 10 is operating in the cooling mode. In the cooling mode, the thermostat 10 is instructing the HVAC system 52 to operate an air conditioning system 54 as shown in FIG. 3 to cool the structure. Indicator 30 will illuminate while the thermostat 10 is operating in the heating mode. In the heating mode, the thermostat 10 is instructing the HVAC system 52 to run a heating system 56 or furnace as shown in FIG. 3 to heat the structure. Finally, the indicator 28 will illuminate while the thermostat 10 is operating in the fan only mode. In the fan only mode, the thermostat 10 is instructing the HVAC system 52 to circulate air through the structure using a fan 58 as shown in FIG. 3 within the HVAC system. Depending on the particular application, the indicator 28 may illuminate whenever the fan 58 is running or may illuminate only when the fan is selected to run continuously.

In embodiments of the present invention that do not utilize automated switching control between the heating and cooling modes of operation, the indicators 26-30 may operate as user selectable switches to allow the consumer to select the operating mode of the thermostat 10. For example, during the summer months the consumer may select the cooling mode by depressing indicator 26. In this mode, the furnace will not be turned on even if the interior ambient temperature drops below the set point. To switch from the cooling to the heating mode of operation, the consumer, in this alternate embodiment, would need to select indicator 30 to allow the thermostat 10 to operate the furnace. Consumer selection in this embodiment of indicator 28 would operate the fan continuously, as opposed to its normal automatic operation based upon a call for cooling or heat by the thermostat 10. In a still further embodiment of the present invention, the indicators 26-30 may also be utilized to provide a visual indication of system trouble or indicate that there is a system reminder message being displayed on the display 16.

The internal temperature sensor 32 is employed to sense an ambient temperature within the structure proximate the sensor. Based on the temperature sensed by the internal temperature sensor 32, the thermostat 10 is able to instruct the HVAC system 52 to ensure that occupant of the structure is kept comfortable and/or the HVAC system is operated efficiently. The thermostat 10 can also be operably coupled to, and in communication with, an external or remote temperature sensor. The remote temperature sensor is remotely located relative to the internal temperature sensor 32 in the thermostat 10 and provides an indication of the temperature at a different location within the structure. Using one or more remote temperature sensors, the thermostat 10 is able to more precisely control temperatures within the structure.

The control logic 34 is generally an electronic device such as, for example, a microprocessor, microcontroller, programmable logic device, integrated circuit, and the like. This control logic 34 controls operation of the thermostat 10 and the connected HVAC or other components.

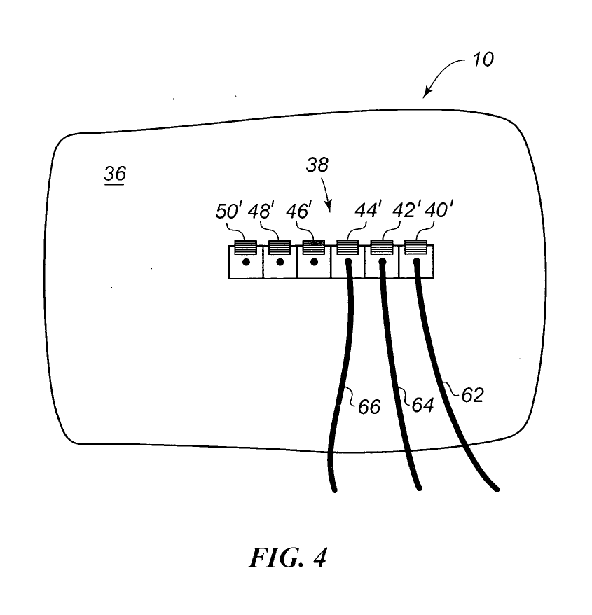

In one embodiment of the present invention that addresses at least the problem of trying to correctly wire and install a thermostat, the control logic 34 is able to sense the presence of a “load” placed on one or more of the terminals 40-50 of FIG. 2 (or tool-less terminals 40′-50′ of FIG. 4). During the installation process the load that is connected to each of these terminals 40-50 is assumed to be one of the HVAC system components (e.g., the air conditioning system 54, the heating system 56, the fan 58, etc.) that has been connected to the thermostat 10 via a control wire 62-66 during the installation process. However, since “correctly” wiring a thermostat is often difficult for many people, the thermostat 10 of this embodiment of the present invention does not require any particular wiring pattern. Instead, the user may simply attach a single wire to a single terminal without regard to location or association and the thermostat 10 will determine how it has been wired and will correctly control the HVAC system.

The control logic 38 is able to sense the presence of any of the HVAC system components that have been connected to the thermostat 10 by monitoring the terminals 40-50. If one or more characteristics at the terminals 40-50 is detected or changes, the control logic 38 is alerted that one of the HVAC components is connected to the thermostat 10. In one embodiment, the characteristic monitored by the control logic 34 is electrical in nature. As such, the control logic 34 monitors the terminals 40-50 for a voltage, a current, an impedance, an inductance, a capacitance, and/or some other electrical characteristic including responses upon application of stimuli as will be discussed more fully below. When such a characteristic is detected or changes, the control logic 34 is alerted to the presence and identity of the HVAC system component.

In addition to monitoring for an electrical characteristic, in one embodiment the control logic 34 observes a thermal characteristic or thermal response. In such a case, after the HVAC system component is sensed, the control logic 34 activates the component and, using the internal temperature sensor 34, monitors the thermal response in the structure. For example, after the control logic 34 senses that one of the HVAC system components has been connected to one of the terminals 40-50 in the terminal block 38, the control logic activates that newly discovered HVAC system component. If the internal temperature sensor 32 senses a steady rise in temperature in the structure, the control logic 34 deduces that the HVAC system component is the heating system 56. As those skilled in the art will recognize, various other thermal responses or characteristics will reveal the particular HVAC component that has been connected to the thermostat 10.

Using the same or similar software and/or firmware as noted above, the control logic 38 is also able to compare characteristics that have been sensed with “known” characteristics of HVAC components. This occurs since many HVAC systems 52 tend to use fairly common or “core” HVAC system components that have very well defined electrical characteristics. For example, if the fan 58 (i.e., an air circulation blower (ACB)) is connected to one of the terminals 40-50 in the terminal block 38 by a wire, the control logic 34 will sense a highly inductive load as well as a particular load current on the wire. Knowing that fans typically produce such a highly inductive loads and the particular load current of that magnitude, the control logic 34 deduces that the fan 58 was connected to that particular terminal.

The control logic 34 simply adjusts the operation of the thermostat 10 to whatever arrangement or configuration has been used to connect the various HVAC system components to the terminals 40-50 on the terminal block 38. Because of this flexibility, the HVAC system components can be connected to the terminals 40-50 by the consumer in any arrangement or configuration and the thermostat 10 and HVAC system 52 will still operated as intended. Simply put, the thermostat 10 is able to “learn” which HVAC system components have been connected to each of the terminals 40-50 and adapt accordingly.

While this embodiment eliminates the need to provide any marking or other indication of terminal functionality, another embodiment provides preferred load markings or indications on the terminals 38. However, if the consumer happens to misconnect some of the wires, the thermostat 10 will compensate. For example, if the consumer were to misconnect the air conditioning system 54 to the terminal normally designated for the heating system 56, the control logic 34 is able to compensate for this mistake by reassigning the functionality of that terminal. This is particularly helpful if the consumer is unable to read and/or decipher any of the markings, colors, symbols, and the like, on the thermostat 10 proximate the terminals 40-50. Indeed, with this functionality the consumer can simply connect all of the HVAC components to the terminals, in any configuration and/or arrangement, and rely on the control logic 34 to figure out which HVAC system components have been connected to each terminal and adapt the operation of the thermostat as needed. As a result, the requirement of connecting each HVAC component to the correct one of the terminals 40-50 is eliminated. Moreover, even the need to mark the terminals 40-50 is removed.

While the terminals 40-50 illustrated in FIG. 2 are shown in a horizontal array on the rear face 36 of the thermostat 10, the terminals 40-50 can be arranged and/or positioned on the thermostat in a variety of different ways. Further, while six of the terminals 40-50 are shown in the illustrated embodiment of FIG. 2, more or fewer of the terminals can be provided depending, for example, on the type of thermostat 10 selected. If the thermostat 10 is a more advanced model or intended to manage more HVAC system components, the thermostat might very well have more than six terminals. In contrast, if the thermostat 10 is very basic and has limited capabilities, only a few terminals may be present. In some circumstances, even when the thermostat 10 is properly installed not all of the terminals 40-50 are used or needed.

As discussed above, each of the terminals 40-50 is typically separated from adjacent terminals by an insulating wall 60. These insulating walls 60 are often integrally formed with the terminal block 38 and made from a material such as, for example, plastic. These insulating walls act as a small retaining wall or fence to ensure that wires 62, 64, 66 leading to the HVAC system components within the HVAC system 52 do not make unintended contact with more than one of the terminals 40-50.

In the illustrated embodiment, each of the terminals 40-50 includes a threaded member 68 (e.g., a screw, bolt, etc.) threadably engaged with a correspondingly threaded terminal plate 70. When the threaded member 68 is driven in a first direction, the threaded member draws closer to the terminal plate 70. In contrast, when the threaded member 68 is driven in a second direction, the threaded member and the terminal plate 70 become further spaced apart from each other. By manipulating the threaded members 68 as noted above, a conductive portion of one or more of the wires 62-66 can be electrically coupled to each of the terminals 40-50.

In the embodiment illustrated in FIG. 2, the terminals 40-50 are screw/terminal plate assemblies. However, this type of a terminal requires the use of a tool, namely a screwdriver, to connect the wires 60-64 thereto. In an alternate embodiment of the present invention, the terminals can be tool-less terminals and/or wire connectors. As shown in FIG. 4, the terminals in an alternate embodiment may be compression terminals 40′-50′ which do not require a screwdriver or other tool to connect the HVAC system wiring thereto. In other embodiments of the present invention, the terminals 40′-50′ can be one or a combination of hinged terminals, barbed terminals, lever and clamp terminals, drop wire terminals, insulation displacement terminals, and twist crimp terminals. As those skilled in the art will appreciate, these types of terminals permit an installer of the thermostat 10 to connect the wires 62-66 to the terminals without having to use a tool (e.g., a screwdriver). In fact, many of these alternative types of terminals permit coupling of the wires 62-66 using one or more fingers. As a result, installation of the thermostat 10 is considerably less burdensome for the installer.

To aid or further aid an installer, one embodiment of the present invention assigns and/or provides each of the terminals 40-50 with a different color (e.g., red, green, yellow, etc.) or color indication. As such, the terminals 40-50 can be visually differentiated from the other terminals quite easily. Preferably, the color allocated to each of the terminals 40-50 matches or corresponds to the color of one of the wires 62-66 leading to the HVAC system 52. For example, a terminal colored red and/or marked with an “R” would correspond to a red wire while another terminal colored and/or identified by a “G” would correspond to a green wire. By color coordinating the terminals 40-50 to the wires 62-66, once again the task of correctly installing the thermostat 10 is made much easier. However, as noted above, in embodiments that utilize the control logic 34 which is able to detect connected HVAC system components and determine what those components are, the use of colors or color designations is not required. Even so, such an option may make installation easier, make a consumer feel more comfortable with the installation process, and/or permit the control logic 34 to adapt more easily.

In yet another embodiment, each of the terminals 40-50 is provided with a marking and/or label to identify that specific terminal. For example, in the climate control and HVAC industry, the letter “R” often signifies that the terminal should be coupled to a voltage source or return. Likewise, the letters “Y” and “W” advise that the terminal should be coupled to a piece of cooling equipment (e.g., the air conditioner 54) and a piece of heating equipment (e.g., the heating system 56), respectively. Also, the letter “F” or “G” notifies an installer that the terminal should be connected to the fan 58. Even further, the letters “O” and “B” are associated with a reversing valve in cool active and heat active modes. This brief recitation of possible markings is intended to be illustrative only and, by no means, exhaustive. Moreover, markings are not restricted to only letters. Other symbols, text, and the like can be employed to identify a particular terminal. In one embodiment, the colors noted above and the markings are employed in combination on the thermostat 10. Again, such markings, although not needed for the thermostat 10 to be installed and connected to the HVAC system components, may provide some piece of mind to the consumer during installation or otherwise make the installation process easier.

Referring to FIG. 3, the HVAC system 52 can also include a terminal block 72 having a plurality of terminals 74, 76, 78, 80, 82, 84. The wires 62-66, which are also illustrated in FIG. 2, are shown coupled to the terminals 74-78. In that way, the control logic 34 in the thermostat 10 is able to control the air conditioning system 54, the heating system 56, and the fan 58 in the illustrated embodiment. As those skilled in the art will recognize, the terminals 74-84 can also be associated with other well known HVAC system components such as, for example, a heat pump, a reversing valve, and the like. Again, this permits the control logic 34 in the thermostat 10 to control the operation of those components. Despite the above, the terminal block 72 can be eliminated if the wires 62-66 are hard wired into the HVAC system 52.

In operation, the thermostat 10 is installed by coupling at least one of the wires 62-64 to any one of the available terminals 40-50 on the terminal block. If the thermostat 10 utilizes a tool-less connector, e.g. such as is illustrated in FIG. 4, connection of the wire can be performed without the need for a tool. In any case, one of the wires is connected and the control logic 34 is able to “sense” the presence of the HVAC component through the wire via one or more characteristics or changes in those characteristics.

After the control logic 34 has determined that one of the HVAC system components is present, the control logic next undertakes the task of determining which of the many HVAC system components has been connected. The control logic 34 performs this task by first measuring and/or monitoring one or more of the characteristics of the attached HVAC system component such as, for example, the air conditioning system 54, the heating system 56, the fan 58, and the like (including, if need be, the wire 62-66). These one or more characteristics can be the same or similar to those used to sense the presence of the HVAC system component.

The control logic 34 next compares the measured and/or monitored characteristic(s) to one or more “known” characteristics of HVAC system components. Using both measured and known electrical characteristics, the control logic 34 can eliminate possibilities of what the HVAC system component may be until arriving at a finite solution set. This is possible because HVAC systems 52 tend to use fairly common core components, of which the electrical characteristics are known. Thereafter, if need be, a measured thermal response characteristic, determined with internal temperature sensor 32, can be compared to the “known” thermal response to further reduce the finite solution set. For example, operation of a fan will likely result in a temperature fluctuation without trending in one way or another. When the finite solution set is pared down enough, the control logic 34 is able to determine which HVAC component is coupled to the chosen terminal. With that knowledge, the control logic 34 adapts the operation of the thermostat 10 to accommodate the connection.

If desired, the learned functionality of each of the wires 62-66 connected to the terminals 40-44 can be displayed on the display. Moreover, the determined components can also be displayed. Still further, the known or sensed characteristics can be stored in a memory associated with the control logic 34.

While the above noted operation discusses only a single wire, each of the wires 62-66 can be connected to the terminals 40-50 all at once. Once all of the wires connected, the control logic 34 can either systematically or simultaneously measure and/or monitor the characteristic(s) for each terminal 40-50 to determine the HVAC components that are connected to each of the terminals 40-50. After the control logic 34 has identified the HVAC component connected to each of the terminals, the thermostat 10 is able to control the HVAC system 52 and ensure the comfort of the occupants or that the HVAC system is run efficiently.

From the foregoing, those skilled in the alt will recognize that the invention provides a “plug and play” quality to, in particular, the residential thermostat. This feature allows anyone, even those without specific technical expertise in HVAC systems or an electrical or mechanical aptitude, to properly install a thermostat in his or her home.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat providing ease of installation of wires connected to heating, ventilating and air conditioning (HVAC) system components, comprising:
a plurality of terminals; and
control logic operatively coupled to the terminals to monitor characteristics thereof, the control logic determining an identity of the HVAC system components by comparing the characteristic monitored on each of the plurality of terminals to a known characteristic of different types of HVAC system components.

2. The thermostat of claim 1, wherein the characteristic monitored by the control logic is an electrical characteristic including one or more of a voltage, current, impedance, inductance, or capacitance.

3. The thermostat of claim 1, further comprising at least one temperature sensor in communication with the control logic, and wherein the control logic is configured to monitor the temperature sensor to determine a thermal response as a result of a stimulus applied to at least one of the terminals to aid in determining the identity.

4. The thermostat of claim 1, wherein at least one of the plurality of terminals is color coded to match standard wiring color coding of HVAC system components.

5. The thermostat of claim 4, wherein the color coding comprises an alphabetic character positioned in proximity to one of the terminals to which a preferred connection of a particular HVAC system component is to be connected.

6. The thermostat of claim 4, wherein at least one of the plurality of terminal comprises a tool-less electrical connector.

7. The thermostat of claim 1, wherein at least one of the plurality of terminal comprises a tool-less electrical connector.

8. The thermostat of claim 7, wherein the tool-less electrical connector is one of a compression terminal, a hinged terminal, a barbed terminal, a lever and clamp terminal, a drop wire terminal, an insulation displacement terminal, or a twist crimp terminal.

9. A thermostat, comprising:
a plurality of electrical terminals for providing electrical connection to heating, ventilating and air conditioning (HVAC) system components; and
means for aiding installation of wires connected to the HVAC system components to the plurality of electrical terminals.

10. The thermostat of claim 9, wherein the means for aiding installation of wires comprises control logic operatively coupled to the electrical terminals to monitor at least one electrical characteristic thereof to determine an identity of the HVAC system components electrically connected thereto.

11. The thermostat of claim 10, wherein the control logic is configured to compare the electrical characteristic to a known characteristic of standard HVAC system components to determine the identity.

12. The thermostat of claim 9, further comprising at least one temperature sensor, and wherein the means for aiding installation of wires comprises control logic operatively coupled to the temperature sensor to monitor a thermal response as a result of a stimulus applied to at least one of the electrical terminals to determine the identity of the HVAC system components electrically connected thereto.

13. The thermostat of claim 12, wherein the control logic determines the identity of the HVAC system component electrically connected to one of the electrical terminals to be a heating component when the temperature sensor monitors an upward trend in sensed ambient temperature upon application of the stimulus to the one of the electrical terminals.

14. The thermostat of claim 12, wherein the control logic determines the identity of the HVAC system component electrically connected to one of the electrical terminals to be a cooling component when the temperature sensor monitors a downward trend in sensed ambient temperature upon application of the stimulus to the one of the electrical terminals.

15. The thermostat of claim 12, wherein the control logic determines the identity of the HVAC system component electrically connected to one of the electrical terminals to be an air moving component when the temperature sensor monitors a variation in sensed ambient temperature without development of an upward or a downward trend upon application of the stimulus to the one of the electrical terminals.

16. The thermostat of claim 9, wherein the means for aiding installation of wires comprises color coding applied to each of the plurality of electrical terminals to match standard wiring color coding of HVAC system components.

17. The thermostat of claim 16, wherein the color coding comprises an alphabetic character signifying the standard wiring color positioned in proximity to one of the electrical terminals.

18. The thermostat of claim 9, wherein the means for aiding installation of wires comprises tool-less connector assemblies associated with the electrical terminals to provide mechanical attachment of the wires to the electrical terminals.

19. The thermostat of claim 18, wherein the tool-less connector assemblies included at least one of compression terminals, hinged terminals, barbed terminals, lever and clamp terminals, drop wire terminals, insulation displacement terminals, or twist crimp terminals.

20. The thermostat of claim 9, further comprising at least one temperature sensor, and wherein the means for aiding installation of wires comprises control logic operatively coupled to the electrical terminals to monitor at least one electrical characteristic thereof to determine an identity of the HVAC system components electrically connected thereto, control logic operatively coupled to the temperature sensor to monitor a thermal response as a result of a stimulus applied to at least one of the electrical terminals to determine the identity of the HVAC system components electrically connected thereto, color coding applied to each of the plurality of electrical terminals to match standard wiring color coding of HVAC system components, and tool-less connector assemblies associated with the electrical terminals to provide mechanical attachment of the wires to the electrical terminals.
